(19) United States
(12) Patent Application Publication
(10) Pub. No.: US 2026/0140401 A1
(43) Pub. Date: May 21, 2026

(54) GRAY SCALE REGULATION DISPLAY STRUCTURE BASED ON PHASE CHANGE MATERIAL

(71) Applicant: Huazhong University of Science and Technology, Wuhan (CN)

(72) Inventors: Hao TONG, Wuhan (CN); QingShan TAN, Wuhan (CN); QiPei ZHOU, Wuhan (CN); Zhang LE, Wuhan (CN); RuiHan LIU, Wuhan (CN); Binhao WANG, Wuhan (CN); Xiangshui MIAO, Wuhan (CN)

(73) Assignee: Huazhong University of Science and Technology, Wuhan (CN)

(21) Appl. No.: 19/300,452

(22) Filed: Aug. 14, 2025

(30) Foreign Application Priority Data
Nov. 20, 2024 (CN) 202411658208.2

(51) Int. Cl. G02F 1/00; G02F 1/17

(52) U.S. Cl. CPC G02F 1/0018; G02F 1/17

(57) ABSTRACT

Provided is a gray scale regulation display structure based on a phase change material, including: phase change material layers, where at least two phase change material layers are disposed, and a crystallization temperature gradient of the phase change material layers is at least 30° C.; dielectric layers, where one dielectric layer is disposed on each of two upper and lower sides of each phase change material layer, and the dielectric layers are used to change crystallization temperatures of the phase change material layers; a thermally isolated layer, located between the phase change material layers; and electrode layers, located on one side or two sides of the dielectric layers and used to perform electric heating driving on the phase change material layers. This disclosure can accurately adjust a gray scale of a phase change display device.

### CROSS-REFERENCE TO RELATED APPLICATIONS

The application claims priority to Chinese patent application No. 202411658208.2, filed on Nov. 20, 2024, the entire contents of which are incorporated herein by reference.

### TECHNICAL FIELD

This disclosure relates to the technical field of phase change display, and in particular, to a gray scale regulation display structure based on a phase change material.

### BACKGROUND

Phase change display technology is unique among numerous display technologies, and the advantages thereof are particularly obvious in comparison. Compared with traditional liquid crystal display (LCD) technology, the phase change display does not require a backlight, and therefore is superior in black display and energy consumption. LCD relies on the rotation of polarized light and liquid crystal molecules to control the display content, which limits its response speed and contrast performance, while the phase change display directly adjusts the transmittance of light through the phase change of the material, providing faster response time and higher contrast.

Compared with organic light emitting diode (OLED) technology, the phase change display also presents non-volatile characteristics. The OLED achieves black display by turning off the pixels, while the phase change display achieves true black display by absorbing light through the amorphous state of the material, avoiding a common burning problem in OLED. In addition, the manufacturing cost and material life of OLED are also challenges it faces, and the phase change display technology presents potential advantages in terms of cost effectiveness and durability due to its material properties and simple manufacturing techniques.

Electrophoretic display (EPD) technology, such as electronic ink, is favored for its low power consumption and paper-like reading experience, but it has a slow refresh rate and is not suitable for dynamic image display. The phase change display technology provides a faster refresh rate and a wider color gamut, making it more advantageous in dynamic content presentation.

In general, the phase change display technology combines the advantages of fast response, high contrast, non-volatility, low energy consumption, form flexibility, and the like, so that the phase change display technology presents unique application potentials and market prospects in competition with traditional display technologies such as LCD, OLED, and EPD.

Based on the phase change display technology of the FP (Fabry-Perot, Fabry-Perot resonant cavity) cavity, the thinner the phase change layer, the greater the optical contrast and the better the display performance generally. The thinner the phase change film, the more difficult the phase change, especially for the same phase change materials. In gray scale adjustment, due to the same crystallization temperatures of the same phase change materials, it is difficult to adjust the gray scale in multi-layer designs.

### SUMMARY

This disclosure provides a gray scale regulation display structure based on a phase change material, to solve a defect that it is difficult to use the phase change material to regulate a gray scale in the prior art, thereby using the phase change material to perform multi-gradient gray scale adjustment.

This disclosure provides a gray scale regulation display structure based on a phase change material, including:
phase change material layers, where at least two phase change material layers are disposed, and a crystallization temperature gradient of the phase change material layers is at least 30° C.;
dielectric layers, where one dielectric layer is disposed on each of two upper and lower sides of each phase change material layer, and the dielectric layers are used to change crystallization temperatures of the phase change material layers;
a thermally isolated layer, located between the phase change material layers; and
electrode layers, located on one side or two sides of the dielectric layers and used to perform electric heating driving on the phase change material layers.

According to the gray scale regulation display structure based on a phase change material provided in this disclosure, when the phase change material layers use same phase change materials, a thickness of at least one layer in same phase change material layers is less than 10 nm.

According to the gray scale regulation display structure based on a phase change material provided in this disclosure, when the phase change material layers use different phase change materials, a phase change temperature difference between different phase change material layers is greater than 30° C.

According to the gray scale regulation display structure based on a phase change material provided in this disclosure, the thermally isolated layer is disposed between two adjacent phase change material layers;
in the electric heating driving, temperatures on two sides of the thermally isolated layer are greater than a phase change temperature of the phase change material layer on one side of the thermally isolated layer; and
the thermally isolated layer has a transparent property.

According to the gray scale regulation display structure based on a phase change material provided in this disclosure, phase change materials used by the phase change material layers are a chalcogenide compound and an alloy thereof, and the phase change materials include one or more of GST, GSST, IST, GeTe, SbTe, BiTe, InSb, InSe, GeSb, GaSb, GeSbTe, AgInSbTe, InSbTe, AgSbTe, Ag₂In₄Sb₇₆Te₁₇(AIST), SbSe, and SbS; and
the phase change materials have variable atomic percentages in chemical formulas and include at least one dopant.

According to the gray scale regulation display structure based on a phase change material provided in this disclosure, the crystallization temperatures of the phase change material layers are increased or reduced through induction or other effects of the dielectric layers.

According to the gray scale regulation display structure based on a phase change material provided in this disclosure, the phase change material layers include a first phase change material layer and a second phase change material layer, the dielectric layers include a first dielectric layer, a second dielectric layer, and a third dielectric layer, and the electrode layers include a first metal layer, a second metal layer, and a third metal layer; and
the first metal layer, the first dielectric layer, the first phase change material layer, the second dielectric layer, the second metal layer, the third dielectric layer, the second phase change material layer, and the third metal layer are sequentially arranged from bottom to top.

According to the gray scale regulation display structure based on a phase change material provided in this disclosure, the first metal layer is a reflection layer, and the first metal layer and/or the second metal layer are/is used to drive the first phase change material layer to undergo a phase change;
the first dielectric layer and the second dielectric layer are used to change a crystallization temperature of the first phase change material layer;
the third metal layer is used as a dielectric layer and is used with the third dielectric layer to change a crystallization temperature of the second phase change material layer, and the third metal layer is used to drive the second phase change material layer to undergo a phase change; and
the third dielectric layer is further used as the thermally isolated layer.

According to the gray scale regulation display structure based on a phase change material provided in this disclosure, the first metal layer uses transparent metal with light absorbance less than a preset threshold from Ag, W, Al, Pt, and Zn; and
the second metal layer and the third metal layer use transparent conductive metal from ITO and INO.

According to the gray scale regulation display structure based on a phase change material provided in this disclosure, the first dielectric layer or the second dielectric layer uses an interface material from TiO₂, TiN, SiO₂, and Al₂O₃, and thicknesses of the first dielectric layer and the second dielectric layer are 5 nm to 500 nm respectively and are obtained according to an integer multiple of one quarter of a wavelength corresponding to a target display color of the gray scale regulation display structure±10 nm; and
the third dielectric layer uses an interface material from Al₂O₃ and SiO₂.

According to the gray scale regulation display structure based on a phase change material provided in this disclosure, the phase change material and the dielectric induction material are used to design the display structure, a crystallization property of the phase change material is affected when the interface material and the phase change material are combined, a gray scale of the phase change material may be accurately regulated, a gray scale of a phase change display device can be adjusted, and most phase change materials are applicable. In addition, the display structure is simple in structure, is not easily affected by an environment, is easy to integrate, and may be designed by changing crystallization temperatures of the same phase change materials.

### BRIEF DESCRIPTION OF THE DRAWINGS

To describe the technical solutions in this disclosure or in the prior art more clearly, the following briefly describes the accompanying drawings required for describing the embodiments or the prior art. Apparently, the accompanying drawings in the following description show merely some embodiments of this disclosure, and those of ordinary skill in the art may derive other accompanying drawings from these accompanying drawings without creative efforts.

FIG. 1 is a schematic distribution diagram showing an impact relationship of a thickness of a phase change display material GST and interface materials TiN and Al₂O₃ on a crystallization temperature thereof in a gray scale regulation display structure based on a phase change material according to this disclosure;

FIG. 2 is a schematic diagram of a phase change temperature test structure of two layers of interface materials and a phase change material in a gray scale regulation display structure based on a phase change material according to this disclosure;

FIG. 3 is a schematic distribution diagram of crystalline and amorphous curves of a phase change material GST sandwiched by an interface material (ZnS)_{0.85}(SiO)_{0.15} in a gray scale regulation display structure based on a phase change material according to this disclosure;

FIG. 4 is a schematic distribution diagram of a gray scale regulation display structure based on a phase change material according to this disclosure; and

FIG. 5 is a schematic diagram of reflectance of an optical structure of a gray scale regulation display structure based on a phase change material according to this disclosure.

### REFERENCE NUMERALS

201. first dielectric layer of a phase change temperature test structure; 202. phase change material layer of the phase change temperature test structure; 203. second dielectric layer of the phase change temperature test structure; 401. first metal layer of a display structure; 402. first dielectric layer of the display structure; 403. first phase change material layer of the display structure; 404. second dielectric layer of the display structure; 405. second metal layer of the display structure; 406. third dielectric layer of the display structure; 407. second phase change material layer of the display structure; 408. third metal layer of the display structure.

### DETAILED DESCRIPTION OF THE EMBODIMENTS

To make the objectives, technical solutions, and advantages of this disclosure clearer, the following clearly and completely describes the technical solutions in this disclosure with reference to the accompanying drawings of this disclosure. Apparently, the described embodiments are some but not all of the embodiments of this disclosure. All other embodiments obtained by those of ordinary skill in the art based on the embodiments of this disclosure without creative efforts shall fall within the protection scope of this disclosure.

In existing display technologies, a phase change display structure formed based on a broadband absorption structure and a narrowband absorption structure composed of a dielectric layer and a metal material mainly adjusts a gray scale by adjusting a crystallization degree of a phase change material. However, a crystallization ratio of the phase change material is difficult to regulate, and the gray scale is unstably adjusted. Alternatively, different combinations of phase change materials with a large difference in phase change temperatures are used for gray scale regulation, but this approach is limited because a selection range of display materials of different combinations of materials becomes very narrow. Alternatively, the same phase change materials are utilized for gray scale regulation, which is performed through driving voltages of different layers. However, since crystallization temperatures of the same phase change materials are the same, it is difficult to control a phase change at one layer only without affecting phase changes at other layers, which will generate great thermal crosstalk and greatly hinder further application of the materials. Therefore, it is of great practical significance to design a display technology for performing accurate gray scale regulation for the same phase change materials.

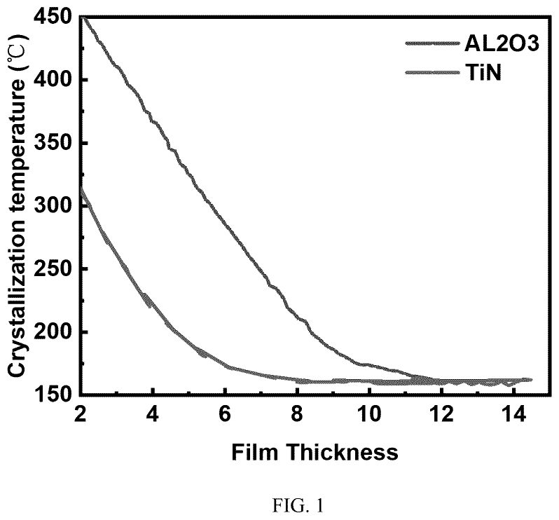

A gray scale regulation display structure based on a phase change material of this disclosure is described below in combination with FIG. 1 to FIG. 5 and includes:
phase change material layers, where at least two phase change material layers are disposed, and a crystallization temperature gradient of the phase change material layers is at least 30° C.;
dielectric layers, where one dielectric layer is disposed on each of two upper and lower sides of each phase change material layer, and the dielectric layers are used to change crystallization temperatures of the phase change material layers;
a thermally isolated layer, located between the phase change material layers; and
electrode layers, located on one side or two sides of the dielectric layers and used to perform electric heating driving on the phase change material layers.

In the embodiment, different dielectric layers are utilized to affect the crystallization temperatures of the phase change material layers. An interface material that may increase or reduce a crystallization temperature of a phase change material is selected to perform a display design on the phase change material, thereby achieving multi-gradient gray scale adjustment.

The display design is performed based on properties that a phase change of a thinner phase change material requires a higher temperature, and different dielectric layers may affect a transition temperature of the phase change of the phase change material. The thinner phase change material indicates a better optical property, a better display effect before and after the phase change, and a greater impact of an interface material on the crystallization temperature of the phase change material. Based on this, a material that may reduce the crystallization temperature of the phase change material is selected to perform a corresponding design according to different reduction degrees.

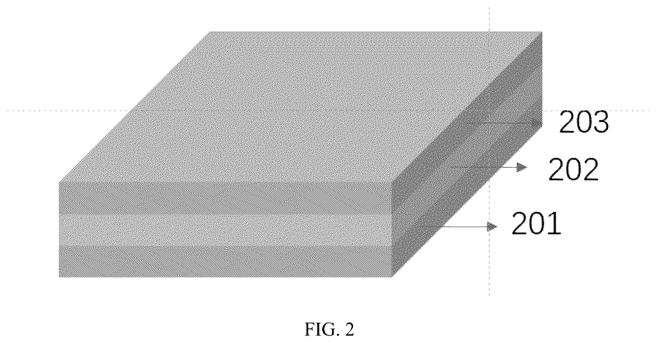

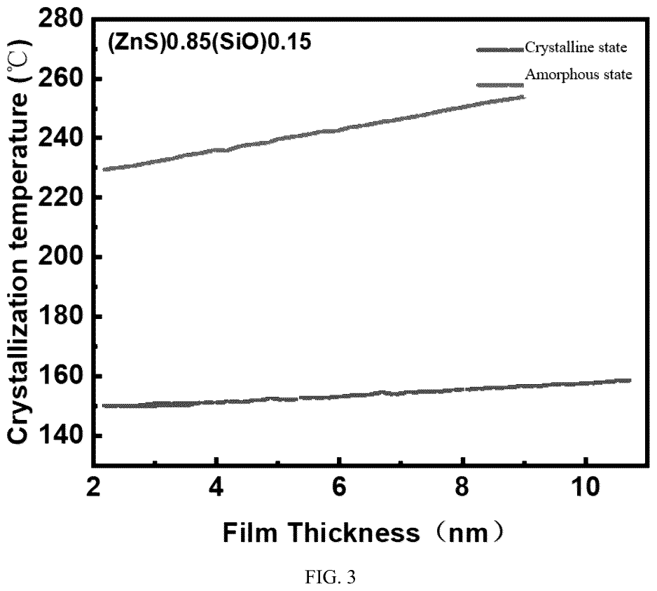

FIG. 2 is a phase change temperature test structure, including a first dielectric layer 201, a phase change material layer 202, and a second dielectric layer 203 from bottom to top in sequence. In the phase change temperature test structure, two layers of interface materials sandwich a phase change material, to measure a change in a phase change temperature of the phase change material with the thickness of the phase change material. Curve diagrams in FIG. 1 and FIG. 3 are obtained through testing based on FIG. 2.

A red curve in FIG. 1 is a curve diagram of a change of a phase change material sandwiched by TiN with the thickness of the phase change material, and a black curve is a curve diagram of a change of a phase change material sandwiched by Al₂O₃ with the thickness of the phase change material. It may be seen that as the thickness of the phase change material reduces, the crystallization temperature of the phase change material will gradually increase, and the phase change material will be greatly affected by the interface material.

Based on this, a property that when the phase change material is thinner, the crystallization temperature of the phase change material is greatly affected by the interface material may be utilized. In addition, the thinner phase change material has good performance before and after the phase change in the display structure, and the phase change material is easy to completely crystallize. The thermally isolated layer with good thermal isolation performance is added between different phase change material layers, thereby further avoiding crosstalk during crystallization of the phase change layer in a phase change display process.

Overall, the embodiment uses a new display structure design idea and successfully develops a display technology that may perform accurate gray scale regulation, to meet the demand for gray scale regulation based on the reflective display market and the like. This technology strategy overcomes the inherent limitations of existing structures, has great technological advancement significance, and opens up new possibilities for the further development of the phase change display technology.

According to the embodiment, the phase change material and the dielectric induction material are used to design the display structure, a crystallization property of the phase change material is affected when the interface material and the phase change material are combined, a gray scale of the phase change material may be accurately regulated, a gray scale of a phase change display device can be adjusted, and most phase change materials are applicable. In addition, the display structure is simple in structure, is not easily affected by an environment, is easy to integrate, and may be designed by changing the crystallization temperatures of the same phase change materials.

Based on the above embodiment, when the phase change material layers use the same phase change materials, the thickness of at least one layer in the same phase change material layers is less than 10 nm.

If a plurality of phase change material layers in the display structure use the same phase change materials, the thickness of at least one layer is less than 10 nm, preferably less than or equal to 6 nm.

When the thickness of the phase change material is less than 10 nm, the phase change temperature may increase. This is because a thinner film makes the phase change material difficult to nucleate in a longitudinal direction, and a role of a coating layer wrapped around the phase change material becomes more and more important.

In an example of GST, it is crucial to ensure that the volume of the phase change material GST is sufficient to maintain vacancies and stability in a cubic phase through resonant bonding. A film as thin as 2 nm thick can crystallize, which is close to the minimum thickness at which the resonant bonding can stabilize the cubic phase. A compressive stress increases the energy required for the Ge atoms to transition from tetrahedral to octahedral coordination, thereby raising the crystallization temperature. Materials such as TiN and Al₂O₃ tend to cause a sharp increase in the crystallization temperature, whereas (ZnS)_{0.85}(SiO)_{0.15}, which applies a lower stress, has little effect on the crystallization temperature, which can be used to design accordingly.

Based on the above embodiment, when the phase change material layers in the embodiment use different phase change materials, a phase change temperature difference between different phase change material layers is greater than 30° C.

Based on the above embodiment, the thermally isolated layer is disposed between two adjacent phase change material layers;
in the electric heating driving, temperatures on two sides of the thermally isolated layer are greater than a phase change temperature of the phase change material layer on one side of the thermally isolated layer; and
the thermally isolated layer has a transparent property.

One thermally isolated layer is added between different phase change material layers, and a thermal isolation material used is transparent and has low light absorbance.

Based on the above embodiment, phase change materials used by the phase change material layers in the embodiment are a chalcogenide compound and an alloy thereof, and the phase change materials include one or more of GST, GSST, IST, GeTe, SbTe, BiTe, InSb, InSe, GeSb, GaSb, GeSbTe, AgInSbTe, InSbTe, AgSbTe, Ag₂In₄Sb₇₆Te₁₇(AIST), SbSe, and SbS.

The phase change materials have variable atomic percentages in chemical formulas and include at least one dopant such as C and N.

Based on the above embodiment, the crystallization temperatures of the phase change material layers are increased or reduced through induction or other effects of the dielectric layers in the embodiment.

There are two types of impacts of the used interface materials on the phase change material of a thin layer: reducing the phase change temperature or increasing the phase change temperature. The interface materials are utilized for combination, to enable the temperature gradient of the phase change materials to be large, and this design can accurately regulate the gray scale of the phase change materials.

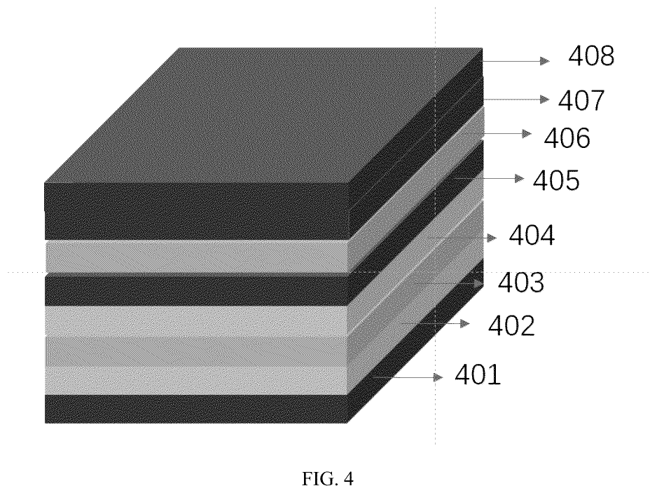

Based on the above embodiment, as shown in FIG. 4, in the embodiment, the phase change material layers include a first phase change material layer 403 and a second phase change material layer 407, the dielectric layers include a first dielectric layer 402, a second dielectric layer 404, and a third dielectric layer 406, and the electrode layers include a first metal layer 401, a second metal layer 405, and a third metal layer 408.

The first metal layer 401, the first dielectric layer 402, the first phase change material layer 403, the second dielectric layer 404, the second metal layer 405, the third dielectric layer 406, the second phase change material layer 407, and the third metal layer 408 are sequentially arranged from bottom to top.

Based on the above embodiment, the first metal layer 401 in the embodiment is a reflection layer, and the first metal layer 401 and/or the second metal layer 405 are/is used to drive the first phase change material layer 403 to undergo a phase change.

The first dielectric layer 402 and the second dielectric layer 404 are used to change a crystallization temperature of the first phase change material layer 403.

The third metal layer 408 is used as a dielectric layer and is used with the third dielectric layer 406 to change a crystallization temperature of the second phase change material layer 407, and the third metal layer 408 is used to drive the second phase change material layer 407 to undergo a phase change.

The third dielectric layer 406 is further used as the thermally isolated layer.

The first metal layer 401 may use metal Ag, which is mainly used as the reflection layer and provides heat, to drive the first phase change material layer 403 to undergo the phase change.

The first dielectric layer 402 may use an interface material TiN. The first phase change material layer 403 may use a phase change material GST. The second dielectric layer 404 may use the interface material TiN and is mainly used with the first dielectric layer 402 to change the crystallization temperature of the first phase change material layer 403.

The second metal layer 405 may use ITO and provide a dielectric layer of an FP cavity. The third dielectric layer 406 may use Al₂O₃ and is mainly used with the third metal layer 408 to change the crystallization temperature of the second phase change material layer 407 film.

The second phase change material layer 407 may use the phase change material GST. The third metal layer 408 may use ITO, and this layer is mainly used to provide heat for driving and is also used as the dielectric layer of the FP cavity.

This design mainly utilizes TiN of the first dielectric layer 402 and the second dielectric layer 404 to change a phase change temperature of GST and also changes the temperatures of the phase change material layers according to Al₂O₃, so that the same phase change materials have different temperature gradients. In this way, phase change materials of different layers may be controlled to undergo the phase change, thereby regulating the gray scale of the display device. At the same time, Al₂O₃ has a thermal isolation effect, which prevents thermal crosstalk between the phase change material layers when the phase change occurs.

The phase change materials of the first phase change material layer 403 and the second phase change material layer 407 can be converted between a crystalline state and an amorphous state under electrical stimulation or laser stimulation, thereby causing transmittance and reflectance of the phase change layers to change.

Metal ITO is deposited on the second phase change material layer 407 on the top layer. The second phase change material layer 407 may control a crystallization state of the phase change material by applying a voltage on ITO of the third metal layer 408. The first phase change material layer 403 may control the crystallization state of the phase change material by applying the voltage on Ag of the first metal layer 401 or ITO of the second metal layer 405.

Specifically, a pulse voltage or laser pulse of medium intensity is applied to the first phase change material layer 403 or the second phase change material layer 407. Under the action of a current or the laser pulse, the temperature of the phase change material rises to a temperature range above the crystallization temperature and below a melting temperature, and is maintained for a certain period of time. At this time, lattices are orderly arranged to form the crystalline state, thereby implementing the transition from the amorphous state to the crystalline state.

A short and strong voltage or laser pulse is applied to the first phase change material layer 403 or the second phase change material layer 407, so that the temperature of the phase change material rises above the melting temperature, thereby destroying a long-range order of the crystalline state. A pulse falling edge is very short, causing the phase change material to be quickly cooled to below the crystallization temperature, so that the phase change material is fixed in the amorphous state, thereby implementing the transition from the crystalline state to the amorphous state. The gray scale of the phase change material is regulated through changes in the transmittance and reflectance of the phase change material of the first phase change material layer 403 or the second phase change material layer 407 during mutual transition of the amorphous state and the crystalline state.

Based on the above embodiment, the first metal layer 401 in the embodiment uses transparent metal with light absorbance less than a preset threshold such as Ag, W, Al, Pt, and Zn, the thickness of the first metal layer is greater than 50 nm, and light cannot pass through the first metal layer.

The second metal layer 405 and the third metal layer 408 use transparent conductive metal such as ITO and INO.

Based on the above embodiment, the first dielectric layer 402 or the second dielectric layer 404 in the embodiment has an impact on a temperature of a thin phase change layer. During design, phase change materials between different layers need to have a sufficiently large temperature gradient, which may be TiO₂, TiN, Al₂O₃, and other interface materials. The thicknesses of the first dielectric layer and the second dielectric layer are 5 nm to 500 nm respectively and are obtained according to an integer multiple of one quarter of a wavelength corresponding to a color that needs to be displayed of the gray scale regulation display structure±10 nm.

The third dielectric layer 406 is mainly used for thermal isolation and may use Al₂O₃, SiO₂, and other interface materials.

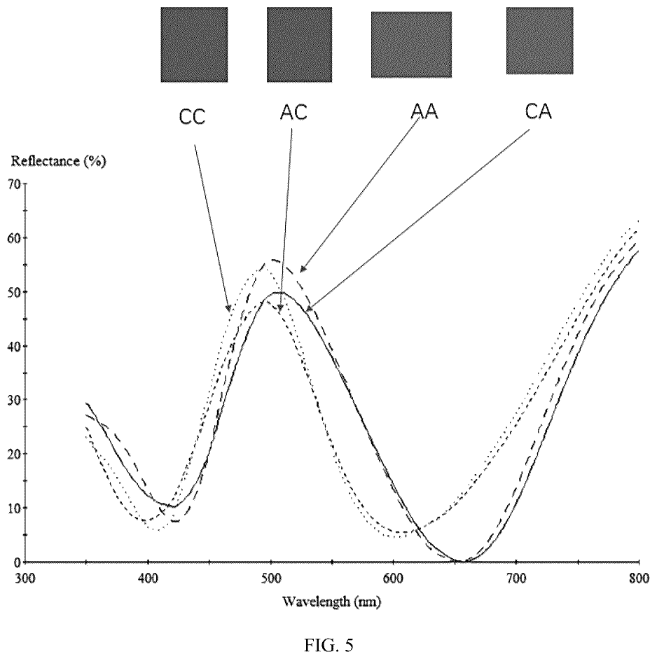

FIG. 5 is a spectral distribution of a combination in the structure shown in FIG. 4. CC indicates that both the first phase change material layer and the second phase change material layer are in the crystalline state; AC indicates that the first phase change material layer is in the amorphous state, and the second phase change material layer is in the crystalline state; AA indicates that both the first phase change material layer and the second phase change material layer are in the amorphous state; and CA indicates that the first phase change material layer is in the crystalline state, and the second phase change material layer is in the amorphous state. Preferably, the first metal layer 401 uses Ag, and the thickness thereof is 100 nm; the thickness of the first dielectric layer 402 is 20 nm; the thickness of the first phase change material layer 403 is 4 nm; the thickness of the second dielectric layer 404 is 20 nm; the thickness of the second metal layer 405 is 210 nm; the thickness of the third dielectric layer 406 is 10 nm; the thickness of the second phase change material layer 407 is 4 nm; and the thickness of the third metal layer 408 is 10 nm. It can be seen from FIG. 5 that when in different states, the phase change layers display differently.

It can be seen from FIG. 1 that when the phase change material GST is sandwiched by the interface materials TiN on two sides, and the thickness of the phase change material is 4 nm, the phase change temperature of the phase change material is about 225° C.; and when the phase change material GST is sandwiched by the interface materials Al₂O₃ on two sides, and the thickness of the phase change material is 4 nm, the phase change temperature of the phase change material is about 350° C. A temperature difference is about 100° C., and this gradient may be utilized for design of phase change display.

Similarly, it can be seen from FIG. 3 that GST sandwiched by (ZnS)_{0.85}(SiO)_{0.15} affects the temperature of GST, that is, the phase change temperature of GST is reduced. This property may be utilized for gradient design of phase change display, thereby regulating the gray scale of the display device.

Finally, it should be noted that the above embodiments are only used to illustrate the technical solutions of this disclosure rather than limiting thereto. Although this disclosure has been described in detail with reference to the foregoing embodiments, those of ordinary skill in the art should understand that the technical solutions recited in the foregoing embodiments may still be modified, or some of the technical features thereof may be replaced with equivalents. These modifications or replacements do not make the essence of the corresponding technical solutions deviate from the spirit and scope of the technical solutions in the embodiments of this disclosure.

What is claimed is:

1. A gray scale regulation display structure based on a phase change material, comprising:
phase change material layers, wherein at least two phase change material layers are disposed, and a crystallization temperature gradient of the phase change material layers is at least 30°C;
dielectric layers, wherein one dielectric layer is disposed on each of two upper and lower sides of each phase change material layer, and the dielectric layers are used to change crystallization temperatures of the phase change material layers;
a thermally isolated layer, located between the phase change material layers; and
electrode layers, located on one side or two sides of the dielectric layers and used to perform electric heating driving on the phase change material layers, wherein
when the phase change material layers use same phase change materials, a thickness of at least one layer in same phase change material layers is less than 10 nm; and
when the phase change material layers use different phase change materials, a phase change temperature difference between different phase change material layers is greater than 30°C.

2. The gray scale regulation display structure based on a phase change material according to claim 1, wherein the thermally isolated layer is disposed between two adjacent phase change material layers;
in the electric heating driving, temperatures on two sides of the thermally isolated layer are greater than a phase change temperature of the phase change material layer on one side of the thermally isolated layer; and
the thermally isolated layer has a transparent property.

3. The gray scale regulation display structure based on a phase change material according to claim 1, wherein phase change materials used by the phase change material layers are a chalcogenide compound and an alloy thereof, and the phase change materials comprise one or more of GST, GSST, IST, GeTe, SbTe, BiTe, InSb, InSe, GeSb, GaSb, GeSbTe, AgInSbTe, InSbTe, AgSbTe, Ag₂In₄Sb₇₆Te₁₇(AIST), SbSe, and SbS; and
the phase change materials have variable atomic percentages in chemical formulas and comprise at least one dopant.

4. The gray scale regulation display structure based on a phase change material according to claim 1, wherein the crystallization temperatures of the phase change material layers are increased or reduced through induction or other effects of the dielectric layers.

5. The gray scale regulation display structure based on a phase change material according to claim 1, wherein the phase change material layers comprise a first phase change material layer and a second phase change material layer, the dielectric layers comprise a first dielectric layer, a second dielectric layer, and a third dielectric layer, and the electrode layers comprise a first metal layer, a second metal layer, and a third metal layer; and
the first metal layer, the first dielectric layer, the first phase change material layer, the second dielectric layer, the second metal layer, the third dielectric layer, the second phase change material layer, and the third metal layer are sequentially arranged from bottom to top.

6. The gray scale regulation display structure based on a phase change material according to claim 5, wherein the first metal layer is a reflection layer, and the first metal layer and/or the second metal layer are/is used to drive the first phase change material layer to undergo a phase change;
the first dielectric layer and the second dielectric layer are used to change a crystallization temperature of the first phase change material layer;
the third metal layer is used as a dielectric layer and is used with the third dielectric layer to change a crystallization temperature of the second phase change material layer, and the third metal layer is used to drive the second phase change material layer to undergo a phase change; and
the third dielectric layer is further used as the thermally isolated layer.

7. The gray scale regulation display structure based on a phase change material according to claim 5, wherein the first metal layer uses transparent metal with light absorbance less than a preset threshold from Ag, W, Al, Pt, and Zn; and
the second metal layer and the third metal layer use transparent conductive metal from ITO and INO.

8. The gray scale regulation display structure based on a phase change material according to claim 5, wherein the first dielectric layer or the second dielectric layer uses an interface material from TiO₂, SiO₂, TiN, and Al₂O₃, and thicknesses of the first dielectric layer and the second dielectric layer are 5 nm to 500 nm respectively and are obtained according to an integer multiple of one quarter of a wavelength corresponding to a target display color of the gray scale regulation display structure±10 nm; and
the third dielectric layer uses an interface material from Al₂O₃, SiO₂, TiN, and TiO₂.
